(19) United States
(12) Patent Application Publication
(10) Pub. No.: US 2019/0104887 A1
(43) Pub. Date: Apr. 11, 2019

(54) HAND OPERATED HERBAL GRINDER

(71) Applicant: James Tussey, Yampa, CO (US)

(72) Inventor: James Tussey, Yampa, CO (US)

(21) Appl. No.: 16/103,592

(22) Filed: Aug. 14, 2018

Related U.S. Application Data
(60) Provisional application No. 62/569,984, filed on Oct. 9, 2017.

(51) Int. Cl. A47J 42/24; B02C 18/14; A47J 42/34

(52) U.S. Cl. CPC A47J 42/24; A47J 42/34; B02C 18/142

(57) ABSTRACT

A hand operated herbal grinder for the disintegration of herbs, spices and plant matter. The apparatus allows a user to place plant matter into the top of a first enclosure. The actuation of the apparatus, particularly through the use of a drive handle rotates blades inward to disintegrate the plant matter with rotational cutting blades.

This application claims the benefit of U.S. Provisional Patent Application 62/569,984 entitled “HAND OPERATED HERBAL GRINDER” filed on Oct. 9, 2017—the entire contents of which are incorporated herein by reference in its entirety for all purposes.

### FIELD OF THE INVENTION

The present invention is directed to an apparatus directed to the use for the disintegration of herbs, spices, and plant matter.

### BACKGROUND OF THE INVENTION

Grinders are commonly used for the disintegration of a variety of materials into smaller particulate form in preparation for use. In the field surrounding cannabis, the disintegration of plant matter is highly desired prior to the use of plant matter in different processes. This includes consumption practices such as smoking, production of food-based marijuana products, or infusing of solvents such as butter for use in cooking. Disintegration may also be desired in preparation for manufacturing processes for producing products such as balms, oils and textiles.

Efforts to disintegrate the plant matter, such as marijuana, involve processing the plant matter into smaller particulate form for ease of use and maximizing utilization of the chemical content of the Tetrahydrocannabinol (THC), Cannabidiol (CBD), or other cannabinoids within the marijuana plant matter. By reducing the plant matter to smaller particulate form, the plant matter exhibits a larger surface area. The larger surface area lends itself to a more efficient and rapid release of chemical compounds and is more suitable for use in processes such as smoking. The smaller particulate form of plant matter is more preferable for the manufacture of marijuana cigarettes and for use in smoking apparatus such as pipes.

Regarding marijuana plant matter, when plant matter is disintegrated, there are a number of different parts of the plant matter which are ground and separated after an initial grinding stage. Some parts of the cannabis plant are known to contain higher levels of cannabinoids and are desired for consumption. Other parts of the plant have low or negligible cannabinoid content and are reserved for other uses or discarded.

A cannabis plant includes many parts which are useful for different purposes. The stalk of the plant is the central stem. It lacks high levels of cannabinoids and can be repurposed for its fiber. The node is the joint where a leaf branches off from the stalk. The large leaf that has the photosynthetic responsibility for the cannabis plant is known as the fan leaf. Fan leaves lack significant levels of cannabinoids, but they have become the unofficial symbol of cannabis. The flower is the part of the female cannabis plant that typically has the highest concentration of cannabinoids, making it the ideal part of the plant for recreational consumption. Flowers grow toward the top of the plant and they are commonly referred to as buds.

The flower comprises many parts. The stem provides the structural support for flowers, while also storing and transporting nutrients for them. Stems aren't known for containing high levels of cannabinoids, but they can be repurposed for their fiber. The cola is a mass of clustered flowers at the top of the cannabis plant. The sugar leaf is a small leaf with low levels of cannabinoids that grows within the flower which is typically trimmed away when the plant is harvested. Sugar leaves are usually covered in high cannabinoid content resin because of its positioning near the resin glands of the plant. Because of their resin coating, sugar leaves are sometimes used when making cannabis edibles. Trichomes are the tiny resin glands of the plant and are located on the flower's leaves and calyces. Trichomes typically have higher concentrations of cannabinoids. Because the resin produced by the trichomes is desired in certain methods of use of cannabis products, certain strains of cannabis are specifically bred for their high trichome production. A calyx (calyces in the plural form), is a floral structure that forms when the flower begins the budding process; it looks like a tubular sheath surrounding the ovule and pistils of the flower. The calyx's trichomes form with their heads pointing toward the top of the calyx. Pistils are the pollen-catching hairs that extend from the calyx. Pistils are not typically known for containing high levels of cannabinoids. The cannabis seed is hidden within a flower's calyx. Besides planting a seed to grow a cannabis plant, oil can be extracted from a cannabis seed to be used in human food or animal feed.

Generally, the disintegration of cannabis plant matter typically surrounds the flower and portions of the flower, preferably separating the parts of the flower having higher cannabinoid content from those parts with lower or negligible cannabinoid content.

### SUMMARY OF THE INVENTION

In the field of use with food goods, spices, herbs and other plant matter, such grinders take on a common form—A cylindrical form, which is used in an upright orientation. Plant matter is placed within a grinding compartment having grinding elements in a radial configuration. A secondary surface having grinding elements is mated with the cylindrical form and the grinding elements of the cylindrical form and the secondary surface interdigitate. The secondary surface is then rotated in relation to the cylindrical form about a central axis. The plant matter interfacing with the interdigitated grinding elements are disintegrated and fall through apertures in the base of the cylindrical form in to a storage compartment. Such cylindrical form grinders include U.S. Pat. No. 7,422,170 to Bao (“Bao”), U.S. Pat. No. 8,220,732 to Griffin, et al. (“Griffin”), U.S. Pat. No. 9,681,777 to Dukat (“Dukat”), U.S. Patent Application No. 2012/0097774 to Hainbach (“Hainbach”), and U.S. Patent Application No. 2014/0217213 Edwards, et al. (“Edwards”)—all of which are incorporated by reference in their entirety herein for all purposes. The above-reference cylindrical grinders use a passive system to transfer ground plant matter from the grinding compartment, through the apertures, and into a storage compartment. Due to this passive system, the ground plant matter only passes through the apertures once they have been substantially disintegrated to an extra-fine particulate size.

The problem with the above referenced grinders is that, due to the passive transfer system, the plant matter is ground into an extra-fine particulate size. When this ground plant matter is placed into a pipe or cigarette for consumption by smoking it, the ground plant matter packs so densely that it is difficult to provide airflow through the ground plant matter and does not burn evenly. As such, this ground plant matter requires high levels of effort by an individual to smoke it.

It is an aspect of certain embodiments of the present invention to create particulate plant matter, particularly cannabis based particulate plant matter, into particles of approximate size between 0.79 mm (0.03125 in) and 3.175 mm (0.125 in). Cannabis particulate plant matter to particles within the identified size range, the particulate plant matter allows for more air gaps and allows air to flow through with less resistance. The result is a lower effort smoking experience and more evenly burning product, and resulting in a more desirable smoking experience. It is a further object of the certain embodiments of the present invention to separate particulate plant matter of differing size for separate uses. It will be appreciated that although it is an aspect of the present invention to disintegrate plant matter into particles larger than produced by some existing solutions, some portions of the plant are naturally smaller than the desired range of particulate plant matter. For instance, the trichomes may have portions of resin (sometimes referred to as kief in the cannabis industry) which may fall off the plant matter during the grinding process. The resin typically forms a particle size less than the desired particulate plant matter size. As the resin contains a high level of cannabinoids, it is desired to retain the resin. The resin can be used for a variety of purposes including supplementing particulate plant matter in consumption, producing hashish, or infusing of solvents such as butter for use in cooking. Certain embodiments of the invention separate resin particles from particulate plant matter.

Certain embodiments surround the disintegration of plant matter using a first and second shaft, each shaft with a plurality of rotary blades. When used, the first shaft rotates in a direction counter to the rotation of the second shaft. The rotary blades are interleaved such that each rotary blade is only adjacent to a counter-rotating rotary blade. Shear plates are interleaved such that a rotary blade has an engineering fit such as a sliding or loose sliding fit with an adjacent rotary blade. Engineering fits, such as a sliding fit, are dictated by ASME Y14.5 (American Society of Mechanical Engineers, 2009, “Dimensioning and Tolerancing,” ASME Y14.5). The rotation of the first and second shafts are counter to each other, and typically rotate such that the upper portion of each rotary blade rotates inward toward the center portion of the grinder.

Certain embodiments of the present invention have a plurality of rotary blades. Each rotary blade has a lobe, and preferably a plurality of lobes. Sides of the rotary blades are configured to interface with static portions of the apparatus. These static portions of the apparatus are referred to as wipers, which serve to clean plant matter which may adhere to the side of a rotary blade. A rotary blade typically has a substantially round form with a plurality of lobes. Each lobe gradually extends away from the center of the rotary blade and terminates with an abrupt radius change to form an edge. When plant material is drawn toward the interface between the rotary blade and an adjacent rotary blade, the plant matter is disintegrated and is disposed into a second enclosure. Any plant matter which adheres to the side of a rotary blade, is wiped by the wiper as the rotary blade rotates away and upward from the second enclosure. The wiping of the rotary blade prevents the rotary blade from carrying disintegrated plant matter from the second enclosure back toward the first enclosure.

Certain embodiments of the present invention comprise a rotary blade further comprising a lobe having a hook form. The hook form is formed by an abrupt radius change of the lobe comprising a radiused form. The hook form extends between the edge of the lobe and a minimum radius of the rotary blade. The hook form serves to pull plant matter toward the interface between the rotary blade and an adjacent rotary blade for disintegration. Certain existing solutions, such as the invention disclosed by U.S. Patent Publication No. 2005/0242221 to Rota (“Rota”), incorporated by reference herein, use shear plates having a radiused lobe. However, the invention of Rota fails to provide a compartment for the capture of plant matter after disintegration or further separation of particulate matter from larger matter.

These and other advantages will be apparent from the disclosure of the inventions contained herein. The above-described embodiments, objectives, and configurations are neither complete nor exhaustive. As will be appreciated, other embodiments of the invention are possible using, alone or in combination, one or more of the features set forth above or described in detail below. Further, this Summary is neither intended nor should it be construed as being representative of the full extent and scope of the present invention. The present invention is set forth in various levels of detail in this Summary, as well as in the attached drawings and the detailed description below, and no limitation as to the scope of the present invention is intended to either the inclusion or non-inclusion of elements, components, etc. in this Summary. Additional aspects of the present invention will become more readily apparent from the detailed description, particularly when taken together with the drawings, and the claims provided herein.

### BRIEF DESCRIPTION OF THE DRAWINGS

FIG. 1A—A perspective of certain embodiments of an apparatus

FIG. 1B—A perspective exploded view of certain embodiments of an apparatus

FIG. 2—A cross sectional view of certain embodiments

FIG. 3—A top plan view of the open top of certain embodiments with detail

FIG. 4A—A side exploded view of certain embodiments

FIG. 4B—A perspective exploded view of certain embodiments

FIG. 5—A side transparent view of certain embodiments

### DETAILED DESCRIPTION OF VARIOUS EMBODIMENTS

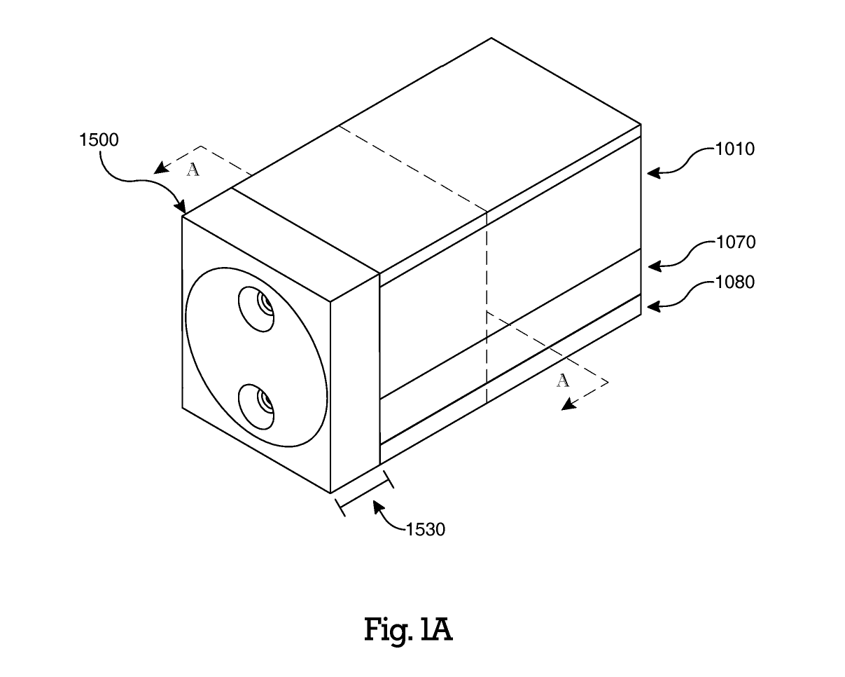

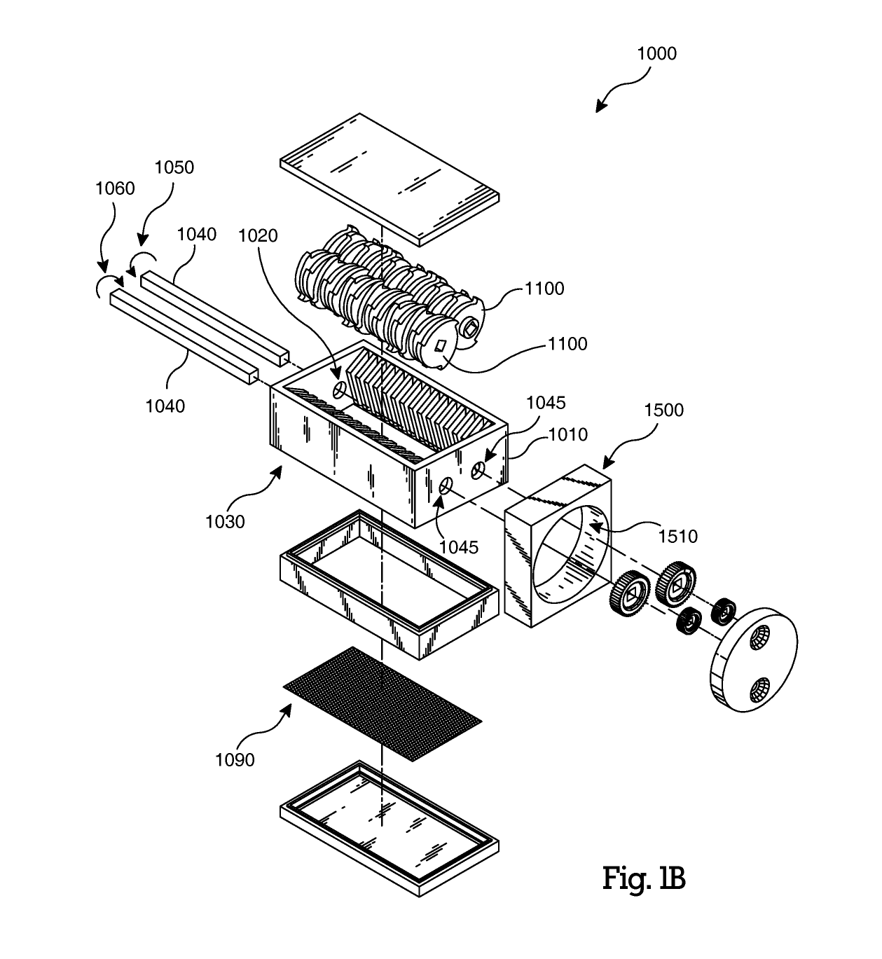

Certain embodiments of the present invention surround an apparatus 1000, shown in FIG. 1B and FIG. 1A, for the disintegration of plant matter into particulate plant matter. Certain embodiments comprise a first enclosure 1010 having an open top 1020 and an open bottom 1030. Such embodiments further comprise a first shaft 1040 having a first rotary blade 1100 and a second rotary blade 1100, and a second shaft 1040 having a third rotary blade 1100. The first rotary blade 1100, the second rotary blade 1100, and the third rotary blade 1100 typically share a substantially similar size and shape. However, it will be appreciated that embodiments are not limited to having rotary blades 1100 of substantially similar size and shape. The first shaft 1040 and the second shaft 1040 are axially constrained by a first aperture 1045 and second aperture 1045 respectively to limit their lateral and axial movement without restricting rotational movement. The first aperture 1045 is configured to allow the slidable passage of a first shaft 1040, and the second aperture 1045 is configured to allow the slidable passage of a second shaft 1040. The first shaft 1040 and the second shaft 1040 are offset from each other. The first shaft 1040 is configured to rotate in a first direction 1050 and the second shaft 1040 is configured to rotate in a second direction 1060. The first shaft 1040 and the second shaft 1040 typically rotate in a manner such that an upper portion 1110 of the first rotary blade and the second rotary blade 1100 rotate toward the second shaft 1040, and an upper portion 1110 of the third rotary blade 1100 rotates toward the first shaft 1040.

Certain embodiments of the present invention (FIG. 1B) comprise a first enclosure 1010 for the disintegration of plant matter and a second enclosure 1070 to capture the resulting particulate plant matter. The second enclosure 1070, disposed below the first enclosure 1010, captures the particulate matter after disintegration within the first enclosure 1010. The second enclosure 1070 of certain embodiments is slidably removable from the first enclosure 1010 for removal of particulate plant matter. Certain embodiments further comprise a third enclosure 1080 having a filtering layer 1090. In certain embodiments the third enclosure 1080 is slidably removable from the second enclosure 1070. The filtering layer 1090 of certain embodiments, allows the passage of particulate matter having a size smaller than the desired particulate matter size, such as resin particles. Thus, the third enclosure 1080, disposed below the second enclosure 1070 captures the particulate matter which passes through the filtering layer 1090, such as resin crystals.

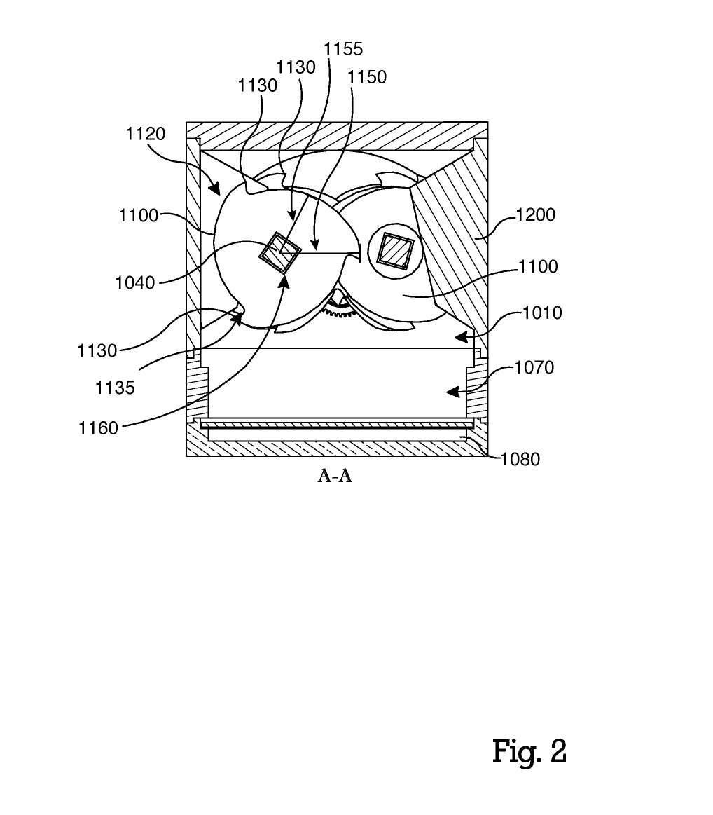

Certain embodiments of the present invention, as seen in FIG. 2, comprise a first shaft 1040 and a first rotary blade 1100. The rotary blade 1100, comprising a first lobe 1120 with an edge 1130, and a second lobe 1120 with an edge 1130, further comprises an aperture. The aperture 1160 of the rotary blade, typically central to the rotary blade 1100, has a profile configured to interface with the cross-sectional profile of the first shaft 1040. In certain embodiments, the aperture 1160 of the first rotary blade is configured to have an engineering fit, such as a location fit, with the cross-sectional profile of the first shaft 1040. In certain embodiments, a first shaft 1040 and an aperture 1160 of a rotary blade comprise a round profile, while other embodiments comprise a square profile. It will be appreciated that the cross-sectional profile of a first shaft 1040 and the profile of an aperture 1160 of a rotary blade of other embodiments comprise shapes not disclosed herein while remaining aligned with the inventive nature of the present invention.

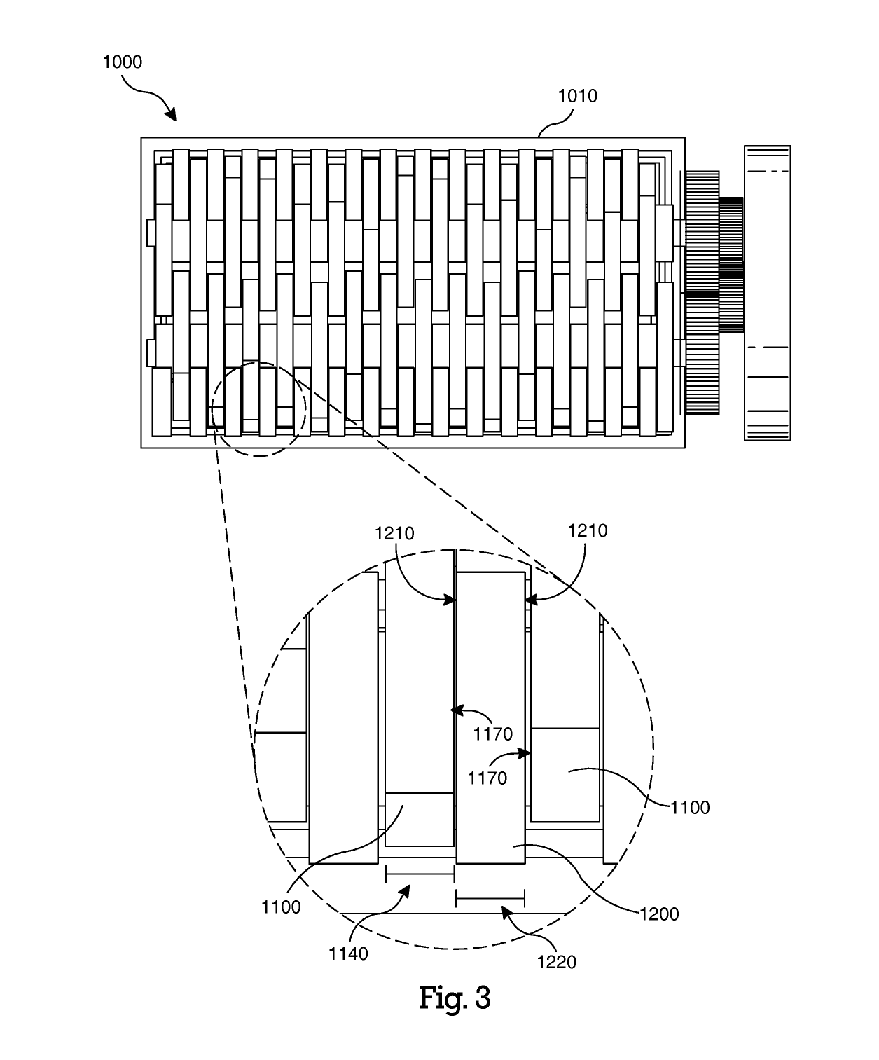

Certain embodiment s of the present invention, shown in FIG. 2 and FIG. 3, comprise a first rotary blade 1100 affixed to a first shaft 1040, with the first rotary blade 1100 having a first lobe 1120 having an edge 1130. The edge 1130 is at the maximum radius 1150 of the rotary blade. A hook form 1135 extends between the edge 1130 of the lobe and a minimum radius 1155 of the rotary blade. A second rotary blade 1100, affixed to a second shaft 1040, has a first lobe having an edge 1130. The first rotary blade 1100 and the second rotary blade 1100 are configured to interface for the disintegration of plant matter such that a first side 1170 of the first rotary blade comprises an engineering fit with a first side 1170 of the second rotary blade. Such embodiments further comprise a first wiper 1200 having a first side 1210 and a second side 1210. The first wiper 1200 comprises a thickness 1220 equal to or greater than a thickness 1140 of the first rotary blade. The first wiper 1200, aligned with and parallel to the second rotary blade 1100 is configured such that a first side 1170 of the adjacent first rotary blade interfaces with the first side 1210 of the wiper with an engineering fit. An engineering fit, will be appreciated to surround engineering dimensioning and tolerances such as those specified by ANSI B4.1 (Standard Tolerance Limits and Fits), incorporated by reference herein. In certain embodiments, a first side 1170 of a rotary blade is configured to have a close sliding fit type of engineering fit. Certain embodiments comprise a third rotary blade having a first side 1170 which interfaces with a second side 1170 of the second rotary blade. In such embodiments, the first side 1210 of the first wiper interfaces with a first side 1170 of the first rotary blade, and a second side 1210 of the first wiper interfaces with a first side 1170 of the third rotary blade.

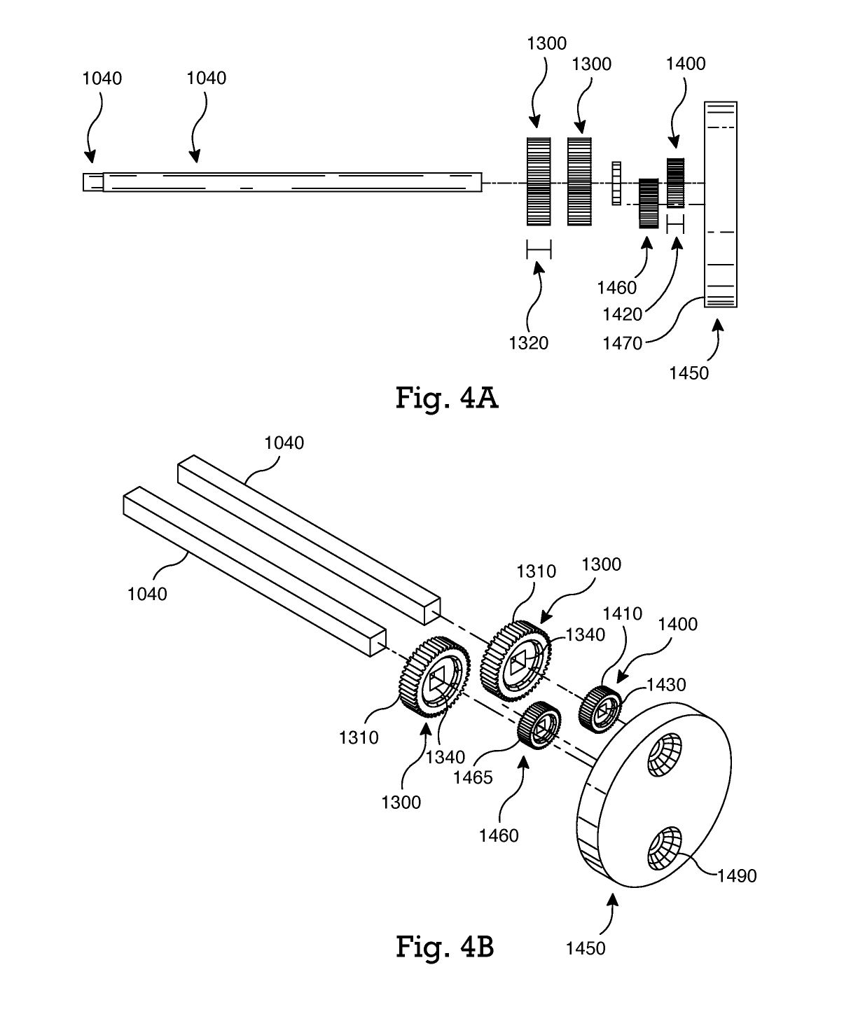

Certain embodiments, shown in FIG. 4A and FIG. 4B, comprise a first shaft 1040 and a second shaft 1040 configured to rotate counter to each other. It will be appreciated that a first shaft 1040 and a second shaft 1040 can be actuated with an actuation mechanism in direct connection or independent of each other. It will be further appreciated that an actuation mechanism can be hand actuated or electrically actuated. In certain embodiments, a first shaft 1040 comprises a first rotary gear 1300 axially affixed to the first shaft 1040, and a second shaft 1040 comprises a second rotary gear 1300 axially affixed to the second shaft 1040. The first rotary gear 1300 comprises teeth 1310 configured to mesh with teeth 1300 of the second rotary gear, thus rotating the second shaft 1040 counter to the rotation of the first shaft 1040 when the first shaft 1040 is rotated.

Certain embodiments, shown in FIG. 4A and FIG. 4B, comprise a first shaft 1040 having a first rotary gear 1300 and a drive gear 1400. The first rotary gear 1300 has an aperture 1340 configured to have an engineering fit, constraining first rotary gear 1300 to the first shaft 1040 when the first shaft 1040 is disposed through the aperture 1340 of the rotary gear. The drive gear 1400 has an aperture 1430 configured to have an engineering fit, constraining the drive gear 1400 to the first shaft 1040 when the first shaft 1040 is disposed through the aperture 1430 of the drive gear. The rotation of the drive gear 1400, causes the rotation of the first shaft 1040 when the drive gear 1400 is rotated. In certain embodiments comprising a drive gear 1400 having teeth 1410, the drive gear 1400 is rotated with a drive handle comprising a gear 1460 with teeth 1465 configured to mesh with the teeth 1410 of the drive gear. In certain embodiments, the drive handle further comprises a disk form with a gear 1460 constrained to a first surface 1470, thus the rotation of the drive handle rotates the drive gear 1400, resulting in the rotation of the first shaft 1040 and the counter-rotation of the second shaft 1040.

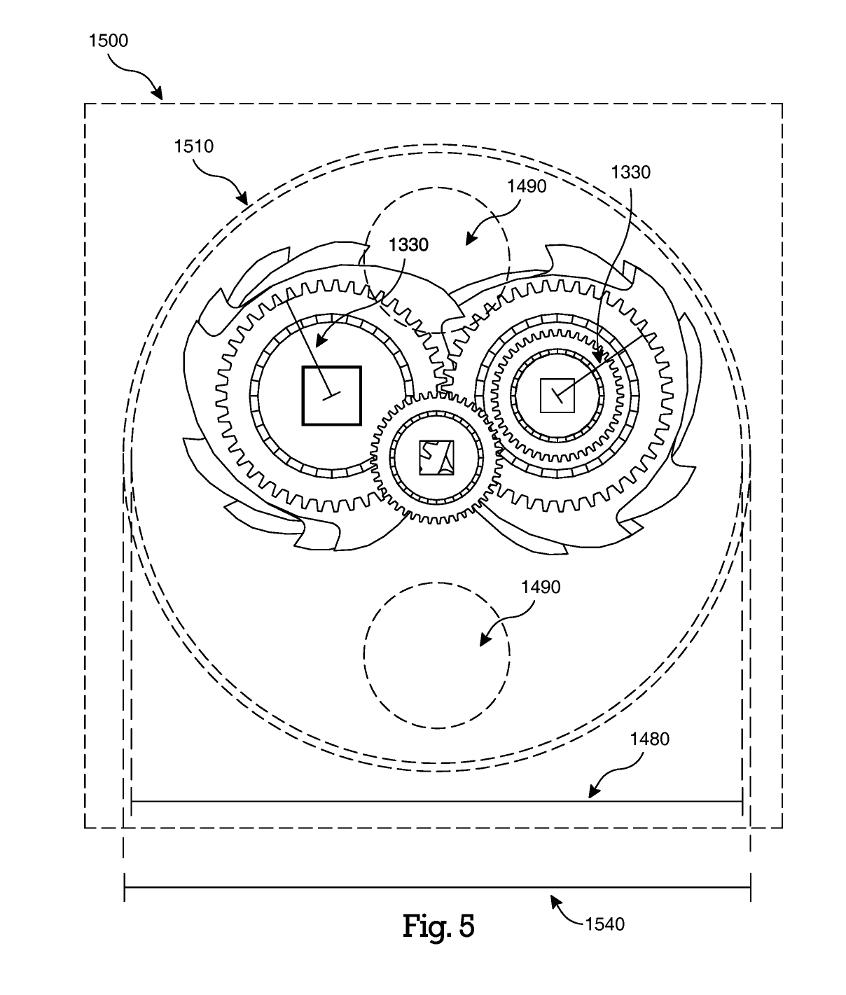

Certain embodiments, referencing FIG. 1A, FIG. 4B, and FIG. 5, comprise a drive housing 1500 which comprises a drive recess 1510, to surround certain elements such as a drive gear 1400. In certain embodiments, a depth 1530 of the drive recess is configured to be equal to, or greater than the depth 1420 of a drive gear and the depth 1320 of the first rotary gear combined. The first aperture 1520 and the second aperture 1520 are offset by a distance equal to the additive total of the root radius 1330 of the first rotary gear and the root radius 1330 of the second rotary gear. In certain embodiments, a drive recess 1510 comprises a circular profile having a diameter 1540 equal to, or greater than the outer diameter 1480 of a drive handle. It will be appreciated that some embodiments comprise a drive handle 1450 and a drive recess 1510 having a sliding fit, clearance fit or other engineering fit. In certain embodiments of the present invention, a drive handle 1450 comprises a first finger recess 1490. It will be appreciated that a finger recess 1490 allows the disposition of a user's finger within it to allow a user to use his or her finger to rotate the drive handle 1450. It will be appreciated that certain embodiments of the present invention comprise a drive handle 1450 having a first finger recess 1490 and a second finger recess 1490. It will be appreciated that in certain embodiments, a drive housing 1500 is integrated into a first enclosure 1010.

While various embodiments of the present invention have been described in detail, it is apparent that modifications and alterations of those embodiments will occur to those skilled in the art. However, it is to be expressly understood that such modifications and alterations are within the scope and spirit of the present invention. Further, the inventions described herein are capable of other embodiments and of being practiced or of being carried out in various ways. In addition, it is to be understood that the phraseology and terminology used herein is for the purposes of description and should not be regarded as limiting. The use of “including,” “comprising,” or “adding” and variations thereof herein are meant to encompass the items listed thereafter and equivalents thereof, as well as, additional items.

What is claimed is:

1. An apparatus for the disintegration of plant matter comprising:
a first enclosure having an open top and an open bottom, the first enclosure having a first shaft and a second shaft;
a first rotary blade and a second rotary blade affixed to the first shaft, the first and second rotary blades spaced equal to or greater than a thickness of a third rotary blade;
the third rotary blade affixed to the second shaft, and disposed between the first rotary blade and the second rotary blade;
the rotary blades having a thickness;
a first wiper aligned with the first rotary blade and having a thickness equal to or less than the thickness of the first rotary blade, and the first wiper having a first side configured to interface with a first side of the third rotary blade;
a second wiper aligned with the second rotary blade, and having a thickness equal to or less than the thickness of the second rotary blade, and the second wiper having a first side configured to interface with a second side of the third rotary blade;
a third wiper aligned with the third rotary blade and having a thickness equal to or less than the thickness of the third rotary blade, the third wiper having a first side configured to interface with a first side of the first rotary blade, and a second side of the third wiper configured to interface with a first side of the second rotary blade; and
a drive handle,
wherein the turning of the drive handle in a first direction rotates the first and second shafts counter to each other, rotating the upper portion of the rotary blades rotates inward toward the center portion of the grinder.

2. The apparatus of claim 1, wherein the drive handle comprises a first finger recess configured to receive a user's finger for rotation of the drive handle.

3. The apparatus of claim 1, further comprising a second enclosure having an open top and open bottom, wherein the open top of the second enclosure is configured to mate with the open bottom of the first enclosure.

4. The apparatus of claim 3, further comprising a third enclosure having an open top, wherein the open top of the third enclosure is configured to mate with the open bottom of the second enclosure.

5. The apparatus of claim 4, further comprising a filtering layer disposed between the third enclosure and the second enclosure.

6. The apparatus of claim 5, wherein the drive handle comprises a first finger recess configured to receive a user's finger for rotation of the drive handle.

7. The apparatus of claim 1, further comprising a top configured to mate with the open top of the first enclosure.

8. The apparatus of claim 1, further comprising a first rotary gear affixed to the first shaft;
a second rotary gear affixed to the second shaft, wherein the second rotary gear is configured to mesh with the first rotary gear;
a drive gear affixed to the first shaft; and
the drive handle having a gear configured to mesh with the drive gear.

9. The apparatus of claim 1, wherein the rotary blades have an aperture configured to match the profile of the shafts, wherein the rotary blades are slidably affixed to the shafts.

10. The apparatus of claim 1, wherein the shafts are axially constrained by apertures in the first enclosure.

11. The apparatus of claim 1, wherein the rotary blades comprise a first lobe having a hook form and an edge.

12. An apparatus for the disintegration of plant matter comprising:
a first enclosure having an open top and an open bottom, the first enclosure having a first aperture and a second aperture for constraining a first shaft, and a third aperture and a fourth aperture for constraining a second shaft;
the first shaft comprising a first rotary blade and a second rotary blade,
the second shaft having a third rotary blade, the third rotary blade disposed between the first rotary blade and the second rotary blade;
the first rotary blade having an aperture configured to mate with the first shaft, and the first rotary blade further comprising three lobes, each lobe having a hook form and an edge, and the first rotary blade having a thickness;
the second rotary blade having an aperture configured to mate with the first shaft, and the second rotary blade further comprising three lobes, each lobe comprising a hook form and an edge, and the second rotary blade having a thickness;
the third rotary blade having an aperture configured to mate with the second shaft, and the third rotary blade further comprising three lobes, each lobe having a hook form and an edge and the third rotary blade having a thickness, the third rotary blade further comprising a first side configured to interface with a first side of the first rotary blade, and a second side of the third rotary blade configured to interface with a first side of the second rotary blade;
a first wiper aligned with the first rotary blade, the first wiper having a thickness equal to or less than the thickness of the first rotary blade, and the first wiper having a first side configured to interface with a first side of the third rotary blade;
a second wiper aligned with the second rotary blade, the second wiper having a thickness equal to or less than the thickness of the second rotary blade, and the second wiper having a first side configured to interface with a second side of the third rotary blade;
a third wiper aligned with the third rotary blade and having a thickness equal to or less than the thickness of the third rotary blade, the third wiper having a first side configured to interface with a first side of the first rotary blade, and a second side of the third wiper configured to interface with a first side of the second rotary blade;
a first rotary gear affixed to the first shaft;
a second rotary gear affixed to the second shaft, with the second rotary gear configured to mesh with the first rotary gear;
a drive gear affixed to the first shaft;
a drive handle having a gear configured to mesh with the drive gear;
a second enclosure having an open top and open bottom, the open top of the second enclosure configured to slidably mate with the open bottom of the first enclosure;
a third enclosure having an open top, the open top of the third enclosure configured to slidably mate with the open bottom of the second enclosure;
a filtering layer disposed between the third enclosure and the first enclosure; and
a top configured to mate with the open top of the first enclosure.
